(19) United States
(12) Patent Application Publication
(10) Pub. No.: US 2007/0022440 A1
(43) Pub. Date: Jan. 25, 2007

(54) Program recommendation via dynamic category creation

(75) Inventor: Srinivas Gutta, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,723

(22) PCT Filed: May 19, 2004
(86) PCT No.: PCT/IB04/01786

§ 371 Date: Nov. 30, 2005

Related U.S. Application Data
(60) Provisional application No. 60/475,165, filed on Jun. 2, 2003.

(51) Int. Cl. H04N 5/445; G06F 3/00; G06F 13/00; H04N 7/025; H04N 7/10

(52) U.S. Cl. 725/46; 725/45; 725/34; 725/35

(57) ABSTRACT

A method for generating recommendations. The method including: entering a newly created preference category (211a) as feedback for generating a recommendation; generating preference information corresponding to the newly created preference category (211a); and generating the recommendation based at least in part on the generated preference information.

The present invention relates generally to recommenders, and more particularly, to a recommender that generates recommendations based at least in part on newly created preference categories.

Explicit based TV recommender systems gather users' preferences via an explicit interface. The user is expected to select from among a pre-defined set of preference categories (alternatively referred to herein as “preferences”), such as station call sign, time of day, day of week, titles, genres like action, comedy-action, suspense-action, comedy, comedy-drama, drama, sports, show ratings (sex, violence, etc.), language description, and sports, such as baseball, football, hockey, soccer, and basketball. The Electronic Program Guide (EPG) provided by Tribune for example has a total of 186 fields, some of which are repeated. As an example there are multiple fields for the shows description, having 10, 20, 40, 80, and 160 characters.

In such an explicit type of TV recommender, a user interface is provided. Beside each button corresponding to the preferences, there is typically a slider provided through which the user is expected to provide information on a 5 point rating system. For example, the user loves the show, likes the show, is neutral about the show, does not like the show, and hates the show. An example of one such recommender is disclosed in co-pending U.S. patent application Ser. No. 09/666,401, filed Sep. 20, 2000, and entitled “Method and Apparatus for Generating Recommendation scores using Implicit and Explicit Viewing Preferences” the entire contents of which is incorporated herein by its reference.

The number of preference categories available with explicit based TV recommender systems is limited and does not cover the broad spectrum of broadcast shows currently shown in TV. In spite of this, current explicit based TV recommendation systems force users to provide preference information via a specific set of pre-defined categories.

Therefore it is an object of the present invention to provide a recommender system for generating recommendations that overcome the disadvantages associated with prior art recommender systems.

Explicit based TV recommender systems of the prior art gather users' preferences via an explicit interface. Such recommenders recommend programs of interest to the user depending upon what categories the user has selected. However, such an interface is often unrealistic, since a user may prefer a category which is not supported by the interface, such as cricket. Towards that end, the apparatus and methods of the present invention provides the ability for the user to dynamically capture the user's viewing preferences by allowing the user to dynamically create preference categories. However, since the newly created preference categories may not be part of the EPG, the apparatus and methods of the present invention may also use representative video clips of the newly created preference categories as opposed to relying on the EPG to provide recommendations to the user.

Accordingly, a method for generating recommendations is provided. The method comprising: entering a newly created preference category as feedback for generating a recommendation; generating preference information corresponding to the newly created preference category; and generating the recommendation based at least in part on the generated preference information.

The generating of the recommendation can generate a recommendation for television programs. In which case, the generating of the preference information preferably comprises: accessing a remote network; searching the remote network for at least one keyword associated with the newly created title; retrieving at least one video clip associated with the at least one keyword resulting from the searching; and generating the preference information from the at least one video clip. The accessing can comprise accessing the Internet. The at least one keyword can comprise a title of the newly created preference category.

The generating of the preference information from the at least one video clip can comprise extracting key frames from the at least one video clip. In which case, the generating of the recommendation preferably comprises generating a user profile based at least in part on the preference information and generating the recommendation based at least in part on the user profile.

Where the generating of the recommendation generates a recommendation for television programs, the generating of the preference information can also comprise: uploading at least one video clip associated with the newly created preference category; and generating the preference information from the at least one video clip. The generating of the preference information from the at least one video clip can comprise extracting key frames from the at least one video clip. In which case the generating of the recommendation can comprise generating a user profile based at least in part on the preference information and generating the recommendation based at least in part on the user profile.

Also provided is an apparatus for generating recommendations. The apparatus comprising: means for entering a newly created preference category as feedback for generating a recommendation; means for generating preference information corresponding to the newly created preference category; and a recommender for generating the recommendation based at least in part on the generated preference information.

The means for generating the preference information can comprise: a modem for accessing a remote network; means for searching the remote network for at least one keyword associated with the newly created title; and means for retrieving at least one video clip associated with the at least one keyword resulting from the searching; means for generating the preference information from the at least one video clip.

The means for generating the preference information from the at least one video clip can comprise means for extracting key frames from the at least one video clip.

In which case the recommender can generate a user profile based at least in part on the preference information and generates the recommendation based at least in part on the user profile.

The means for generating the preference information can also comprises: means for uploading at least one video clip associated with the newly created preference category; and means for generating the preference information from the at least one video clip.

The means for generating the preference information from the at least one video clip can comprise means for extracting key frames from the at least one video clip. In which case the recommender can generate a user profile based at least in part on the preference information and can generate the recommendation based at least in part on the user profile.

Also provided are a computer program product for carrying out the methods of the present invention and a program storage device for the storage of the computer program product therein.

Specifically, a program storage device readable by machine, tangibly embodying a program of instructions executable by the machine to perform method steps for method for generating recommendations is provided. The method comprising: entering a newly created preference category as feedback for generating a recommendation; generating preference information corresponding to the newly created preference category; and generating the recommendation based at least in part on the generated preference information.

Still yet provided is a computer program product embodied in a computer-readable medium for generating recommendations. The computer program product comprising: computer readable program code means for entering a newly created preference category as feedback for generating a recommendation; computer readable program code means generating preference information corresponding to the newly created preference category; and computer readable program code means generating the recommendation based at least in part on the generated preference information.

These and other features, aspects, and advantages of the apparatus and methods of the present invention will become better understood with regard to the following description, appended claims, and accompanying drawings where:

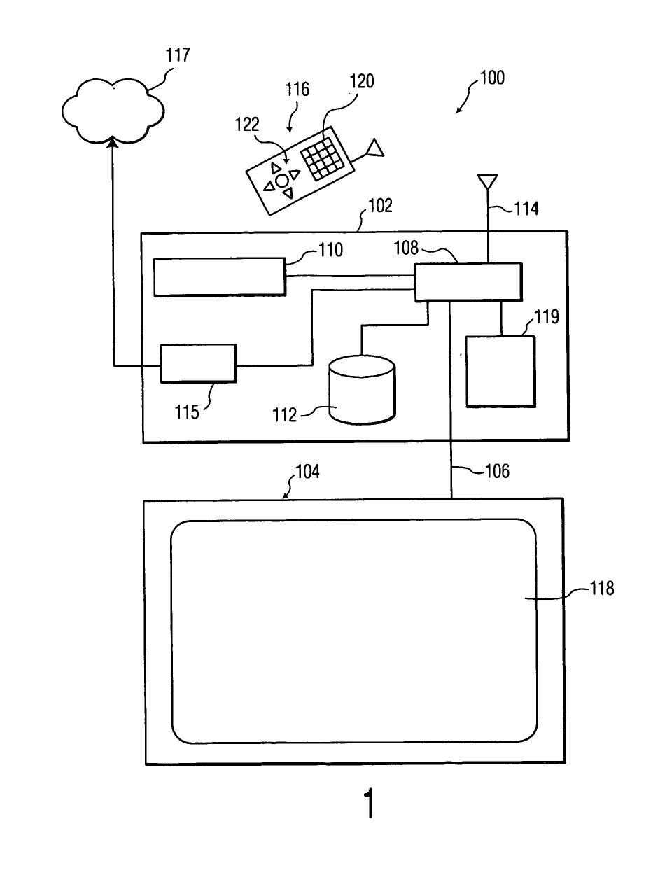

FIG. 1 illustrates a schematic illustration of a preferred implementation of an apparatus for carrying out the methods of the present invention.

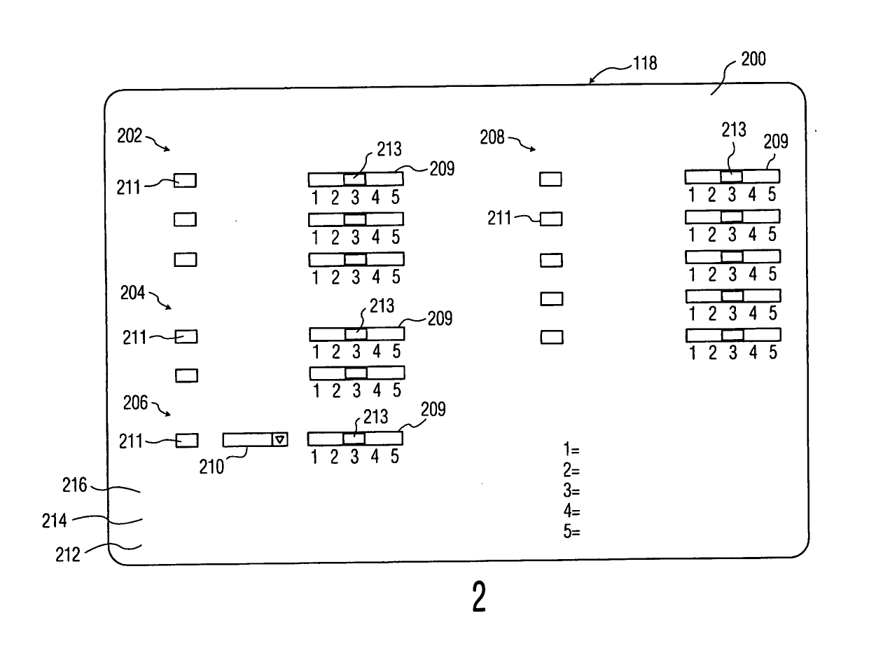

FIG. 2 illustrates a preferred implementation of a user interface for dynamically creating new preference categories.

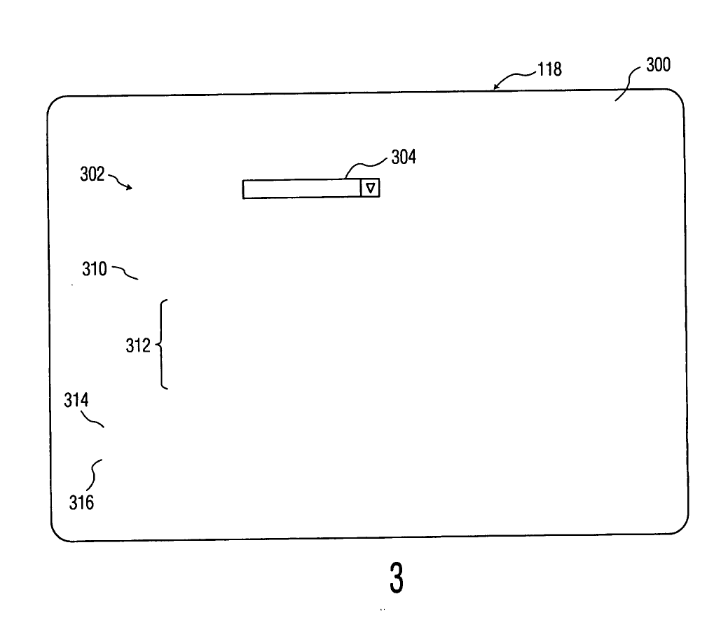

FIG. 3 illustrates a preferred implementation of a user interface for entering the newly created preference category information.

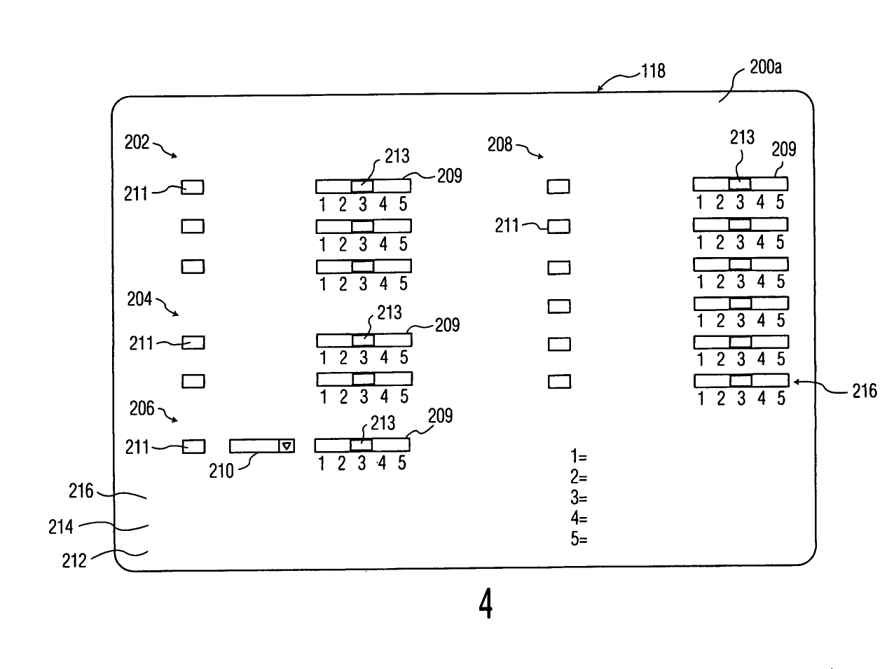

FIG. 4 illustrates the user interface of FIG. 2 modified with an additional preference category.

Although this invention is applicable to numerous and various types of content for which a recommendation is made, it has been found particularly useful in the environment of video content and more particularly in the environment of television programming. Therefore, without limiting the applicability of the invention to generating a recommendation for video content and television programming, the invention will be described in such environment.

Referring now to FIG. 1, there is shown a preferred implementation of an apparatus for generating recommendations, the apparatus being generally referred to by reference numeral 100. The apparatus 100 is preferably configured in a set-top box 102 operatively connected to a display 104, such as a television, by way of a video output 106. However, those skilled in the art will appreciate that the apparatus 100 can be integrally formed in the display 104. The set-top box 102 includes a central processor 108 operatively connected to a recommender 110, a storage device 112, a receiver 114, a communication means 115, such as a modem, and a data input means 119.

The recommender 110, alternatively referred to as a recommender engine, generates recommendations for video content, such as television program, or other content in response to user feedback and/or viewing habits of a user. Such recommenders 110 are well known in the art, such as that disclosed in U.S. application Ser. No. 09/666,401 filed on Sep. 20, 2000 and entitled “Method and Apparatus for Generating Recommendation Scores Using Implicit and Explicit Viewing Preferences”, the contents of which is incorporated herein by its reference. The storage device 112, such as a hard drive, stores video content for later viewing by the user and program instructions for operation of the apparatus. Although the recommender 110 is shown schematically as a separate device, it may also be contained in a set of program instructions on the storage device 112. Furthermore, although the storage device 112 is shown as a single device, it may comprise two or more storage devices, each of which is operatively connected to the processor 108. The modem 115, under the control of the processor 108 is operatively connected to a network 117 for receiving data from the network 117 or sending data to the network 117. The data input means 119 can be a floppy disk drive, CD drive, DVD drive, or other means for reading a portable storage medium. The data input means 119 may also be a connector, such as a USB port, for connecting to another device, such as a computer, for uploading data to the apparatus 100.

The receiver 114 receives wireless signals from a remote control 116 indicating control signals for remote operation of the apparatus and for entering information into the apparatus through a user interface reproduced on a screen 118 of the display 104. The processor 108 receives the wireless signals from the remote control 116 and has means for de-multiplexing the same from other signals or noise and for transforming the same, if necessary, to be usable with the apparatus 100. The processor 108 further controls the recommender 110 and storage device 112, generates the user interface, and outputs the same to the display 104 for viewing on the screen 118. As is well known in the art, a user enters and traverses the user interface with the remote control 118 by pressing simple buttons 120 and/or manipulating a joystick button 122 on the remote control.

Referring now also to FIGS. 2 and 3, a preferred implementation of a method for generating recommendations will be discussed. As discussed above, some types of recommenders use feedback from a user to help in generating a recommendation for video or other content The recommendation can be based partially or wholly on the feedback. Generally, a user interface, referred to in FIG. 2 by reference numeral 200, is generated and viewed on the screen 118 of the display 104 under control of the processor 108. The user interface prompts a user for feedback on at least one preference for generating a recommendation. Examples of preferences include a preferred time slot 202, such as prime time, late night, and weekend; a preferred language 204, such as English or Spanish; a preferred actor 206; and a preferred sports 208, such as baseball, football, basketball, hockey, and soccer. The user interface 200 may also ask the user to weigh each selected preference, such as by providing a slider 209 having a five-point weighing scale as discussed above.

The preferences 202-208 can be selected by traversing the list with the joystick button 122 on the remote control 116 and pressing an enter button when a button 211 corresponding to an appropriate preference 202-208 is highlighted or by traversing to a drop-down list 210 corresponding to one or more of the preferences 202-208 and selecting an entry in the drop-down list 210. Once selected, the preferences preferably remain highlighted to provide the user with a “map” of his or her preferences. The sliders 209 are similarly selected and once selected, a corresponding weight to be assigned to the corresponding preference can be entered by using the joystick button 122 to move a slider button 213 left or right. Alternatively, the weight can be entered by entering a numerical value between 1 and 5. Of course, the preferences 202-208 are given by way of example only, not intended to be an exhaustive listing thereof, and are further not intended to limit the scope or spirit of the invention to those described. For example, other preferences include genre, station call signal, ratings, and day of week. A “Create New Preference Category” 214 choice is provided for creating additional preference categories to add to the viewing preferences 202-208, as discussed below. Furthermore, an “Enter Preferences” 216 choice is provided on user interface 200 to enter the highlighted preferences for use in generation of a recommendation. Lastly, an “Exit” 212 choice is also provided on the user interface 200 to exit the feedback process and resume another operation of the apparatus 100 or display 104.

In general, the methods of the present invention permit a user to define and create additional preference categories that are not supported by the recommender or by the EPG. It is well know that the performance of a TV recommender is very much dependent on the type of preference information provided by the user. As discussed above, recommenders of the prior art permit users to give preference information via a set of pre-defined show categories. Furthermore, the EPG itself has a pre-defined set of categories. For example, if the user likes games such as shuttle/badminton, cricket, there is no way for him/her to provide this information since such a category does not exist in the EPG information. Therefore, the methods and apparatus of the present invention provide flexibility for the user to dynamically create additional preference categories. However, since the user created categories may not be supported by the EPG, the methods may be supplemented such that the system is aware of where to find/generate information pertaining to these new categories.

The user creates the new preference categories with the use of an appropriate user interface that allows for new buttons 211a (see FIG. 4) to be created for the new categories. Preferably, the user enters the new preference category information as a manual operation by selection of the “Create New Preferences Category” 214 choice on user interface 200. Such a selection preferably switches the user interface to a user interface shown in FIG. 3, referred to generally by reference numeral 300. Alternatively, user interface 300 can pop-up as a window without replacing user interface 200.

User interface 300 allows a user to add one or more additional preference categories to user interface 200. The user interface 300 contains a title field 302. The title can be entered alphanumerically by depressing appropriate buttons on the remote control (or other data entry device, such as a keyboard). For example a user can select the title “Sports/Cricket” or simply “cricket” if he or she would like to add such a preference category to user interface 200. The user interface 300 is equipped with a search engine that searches a remote database and/or a remote network, such as the Internet for video clips representative of the title. Alternatively, a “keywords” field can be provided and the search engine will search the keywords entered instead of, or in addition to, the title. If the user enters “sports/cricket” in the title field 302 (or alternatively in a keywords field) the search agent searches for video clips that pertain to the game cricket on the Internet and retrieves the clips to the apparatus 100 for storage on the storage device 112. The user interface 200 then creates a new category called “cricket” under “Preferred Sports” 208 and links this category to the clips found. As discussed above, by default, the title of the new category is used as the keyword for searching. However, an additional field can be supplied on user interface 300 for entering keywords to be searched in addition to the title or instead of the title.

Instead of searching a database or the Internet for clips representative of the newly created preference category, the user can alternatively provide a specific clip or set of clips and upload them onto the system and associate these clips with the newly created preference category. Therefore, interface 300 includes an “Upload Clip/Trailer” 310 choice as well as entering a location 312 where the clip/trailer is uploaded. Preferably, the user provides a portion of a TV show or clip representative of the newly created preference category to the apparatus 100 through the data input means 119, such as on a DVD or other storage medium, via the communication means 115, or through a connector, such as a USB port. A “Back” 316 choice is also provided on user interface 300 to return to user interface 200. If user interface 300 is a window, the “Back” 316 choice is replaced with a “Close Window” choice.

After entering the title (and/or keywords) and/or a location for a representative clip, the user selects the “Add New Preference Category to Viewing Preferences” 314 choice, the apparatus then searches a remote database or the internet for representative clips of the newly created preference category and/or uploads an indicated representative clip. The apparatus then reconfigures user interface 200, as shown in FIG. 4 to include the newly created preference category, e.g., “cricket” 211a, the reconfigured user interface being generally referred to by reference numeral 200a. Although the example discussed and described above creates a subcategory of “cricket” under the “Preferred Sports” category 208, such is shown by way of example only and not intended to limit the scope and spirit of the present invention to creation of sub-categories of existing preference categories. Those skilled in the art will appreciate that entirely new categories can also be created as well as sub-categories therefore. At user interface 200a, the user then, provides the degree of likeness to the newly created preference category (categories) the same way he/she provided to existing categories on the user interface 200.

Generation of a recommendation to the user for cases where the preference information provided by the user is based on pre-defined categories is done in any number of ways known in the art, such as that disclosed in U.S. application Ser. No. 09/666,401 filed on Sep. 20, 2000 and entitled “Method and Apparatus for Generating Recommendation Scores Using Implicit and Explicit Viewing Preferences.”

However, where the preference information provided by the user is based on one or more of the newly created preference categories 211a, the information from the representative clips are used, as disclosed in co-pending U.S. Provisional Application Ser. No. 60/462,778 (attorney Docket # US030087, filed on 14 Apr. 2003, and entitled “Generation of Implicit TV Recommendations via Shows Image Content,” the entire contents of which is incorporated herein by its reference. In summary, key frames of the clips are extracted from the video clips that are representative of the newly created preference category as well as EPG information (if any), a user profile is generated based at least in part on the extracted key frames and EPG information, and a viewing recommendation is generated based on the user profile.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device, such as storage device 112.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for generating recommendations, the method comprising:
entering a newly created preference category (211a) as feedback for generating a recommendation;
generating preference information corresponding to the newly created preference category (211a); and
generating the recommendation based at least in part on the generated preference information.

2. The method of claim 1, wherein the generating of the recommendation generates a recommendation for television programs.

3. The method of claim 2, wherein the generating of the preference information comprises:
accessing a remote network (117);
searching the remote network (117) for at least one keyword associated with the newly created preference category (211a);
retrieving at least one video clip associated with the at least one keyword resulting from the searching; and
generating the preference information from the at least one video clip.

4. The method of claim 3, wherein the accessing comprises accessing the Internet.

5. The method of claim 3, wherein the at least one keyword comprises a title of the newly created preference category (211a).

6. The method of claim 3, wherein the generating of the preference information from the at least one video clip comprises extracting key frames from the at least one video clip.

7. The method of claim 6, wherein the generating of the recommendation comprises generating a user profile based at least in part on the preference information and generating the recommendation based at least in part on the user profile.

8. The method of claim 2, wherein the generating of the preference information comprises:
uploading at least one video clip associated with the newly created preference category (211a); and
generating the preference information from the at least one video clip.

9. The method of claim 8, wherein the generating of the preference information from the at least one video clip comprises extracting key frames from the at least one video clip.

10. The method of claim 9, wherein the generating of the recommendation comprises generating a user profile based at least in part on the preference information and generating the recommendation based at least in part on the user profile.

11. An apparatus (100) generating recommendations, the apparatus comprising:
means for entering a newly created preference category (211a) as feedback for generating a recommendation;
means for generating preference information (108, 115, 117) corresponding to the newly created preference category (211a); and
a recommender (110) for generating the recommendation based at least in part on the generated preference information.

12. The apparatus of claim 11, wherein the means for generating the preference information comprises:
a modem (115) for accessing a remote network (117);
means (108) for searching the remote network for at least one keyword associated with the newly created preference category (211a); and
means (108) for retrieving at least one video clip associated with the at least one keyword resulting from the searching;
means (108) for generating the preference information from the at least one video clip.

13. The apparatus of claim 12, wherein the means for generating the preference information from the at least one video clip comprises means (108) for extracting key frames from the at least one video clip.

14. The apparatus of claim 13, wherein the recommender (110) generates a user profile based at least in part on the preference information and generates the recommendation based at least in part on the user profile.

15. The apparatus of claim 12, wherein the means for generating the preference information comprises:
means (115) for uploading at least one video clip associated with the newly created preference category (211a); and
means (108) for generating the preference information from the at least one video clip.

16. The apparatus of claim 15, wherein the means for generating the preference information from the at least one video clip comprises means (108) for extracting key frames from the at least one video clip.

17. The apparatus of claim 16, wherein the recommender (110) generates a user profile based at least in part on the preference information and generates the recommendation based at least in part on the user profile.

18. A program storage device readable by machine, tangibly embodying a program of instructions executable by the machine to perform method steps for method for generating recommendations, the method comprising:
entering a newly created preference category (211a) as feedback for generating a recommendation;
generating preference information corresponding to the newly created preference category (211a); and
generating the recommendation based at least in part on the generated preference information.

19. A computer program product embodied in a computer-readable medium for generating recommendations, the computer program product comprising:
computer readable program code means for entering a newly created preference category (211a) as feedback for generating a recommendation;
computer readable program code means generating preference information corresponding to the newly created preference category (211a); and
computer readable program code means generating the recommendation based at least in part on the generated preference information.
